(19) United States
(12) Patent Application Publication
(10) Pub. No.: US 2006/0271582 A1
(43) Pub. Date: Nov. 30, 2006

(54) System and method for analyzing raw data files

(75) Inventor: Darryl Victor Collins, Jindalee (AU)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/136,444

(22) Filed: May 25, 2005

(51) Int. Cl. G06F 7/00

(52) U.S. Cl. 707/102

(57) ABSTRACT

A method and system are disclosed for generating and displaying a custom report based on raw data files received from work machines in a construction site. The method includes receiving raw data files and queries from a user. The query may be parsed into components. A heuristic may be applied to the parsed components to generate a filter. The filter may operate on the data in the raw data files to generate the custom report and the custom report may be displayed to the user.

### TECHNICAL FIELD

The present disclosure relates to a system and method for analyzing raw data files and, more particularly, to a system and method for analyzing raw data files received from multiple sources.

### BACKGROUND

Equipment monitoring and tracking systems typically receive large quantities of data from various sensors associated with objects to be monitored or tracked. Users may be interested in having quick access to the collected data to identify trends and patterns that may be indicative of problems in the equipment, to track locations of items, and for various other purposes.

However, the data collected from a single piece of equipment is typically received as a raw data file, meaning it is received in its original format as produced by a processor on board each piece of equipment. Thus, a standardized format is often applied to cross-reference or index certain fields in the raw data files, thereby providing meaningful analysis of the collected data files.

A relational database may be used to reformat and crossreference raw data files to permit monitoring and tracking of a large number of equipment entities. However, the amount of data that can be viewed and analyzed by a relational database is often limited by memory constraints. Adding relational indices and reformatting the raw data files tends to increase file sizes and, therefore, exacerbates the problem of storing data. Archiving data may reduce the amount of memory required to perform an analysis of data, but archiving significantly increases an amount of time needed to access the archived data. When analyzing machine performance or investigating failures, users may wish to examine historical data to learn whether any early indications of problems were evident. To do this with existing systems, the data must be re-imported from an archive into the database before being viewed. This requires additional time and complicates the maintenance of the database.

In addition, a relational database may permit Structured Query Language (SQL) (an industry standard language) queries to access information about underlying data files, but some queries that would seem natural to a user are difficult to form ad-hoc in a relational database and may be slow to execute. Stored procedures can be written to provide new verbs to use in a query, but this requires expertise that an end user may not have. Furthermore, stored procedures can be written for a specific relational database but may be incompatible for use on other relational databases.

At least one system has been developed for providing meaningful analysis of large numbers of raw data files. For example, U.S. Pat. No. 6,754,654 (“the '654 patent”), issued to Kim et al. on Jun. 22, 2004 describes a data mining system for extracting data from raw documents, such as e-mails. Particularly, the system of the '654 patent includes a data retrieving component for automatically determining whether a raw document is pertinent and for generating marked-up documents having a standardized format based on the raw documents. The system of the '654 patent further includes a data integrating component for filtering out excess words from the marked-up documents, identifying and storing key words from the marked-up documents, and generating data cubes that cross-reference fields in the marked-up documents with personnel information. The filtered marked-up documents, key words, and summary information are referred to as “intermediate data,” which a query manager may use to compute responses to user-entered queries.

While the system of the '654 patent may be effective for rapidly processing queries on data, the system of the '654 patent includes several disadvantages. For example, the system requires pre-processing of raw data files before queries may be performed on them. To be effective, the excess information must be filtered out of the raw data files, which may result in loss of important information. In addition, the data cubes that cross-reference marked-up documents with other information take up valuable memory space.

The present disclosure is directed to overcoming one or more of the problems or disadvantages existing in the prior art.

### SUMMARY OF THE INVENTION

One disclosed embodiment includes a method for generating and displaying a custom report based on raw data files. The method includes receiving raw data files, receiving a query from a user, parsing the query into components, applying a heuristic to the parsed components to generate a filter, using the filter to generate a custom report based on data in the raw data files, and displaying the custom report to the user.

A second disclosed embodiment includes a console for generating and displaying a custom report based on raw data files. The console may be adapted to receive raw data files, receive a query from a user, parse the query into components, apply a heuristic to the parsed components to generate a filter, use the filter to generate a custom report based on data in the raw data files, and display the custom report to the user.

### BRIEF DESCRIPTION OF THE DRAWINGS

FIG. 1 provides a diagrammatic illustration of a system, according to an exemplary disclosed embodiment.

FIG. 2 provides a view of a user interface display, according to an exemplary disclosed embodiment.

FIG. 3 provides a flow chart of an exemplary method that may be performed by the disclosed system.

### DETAILED DESCRIPTION

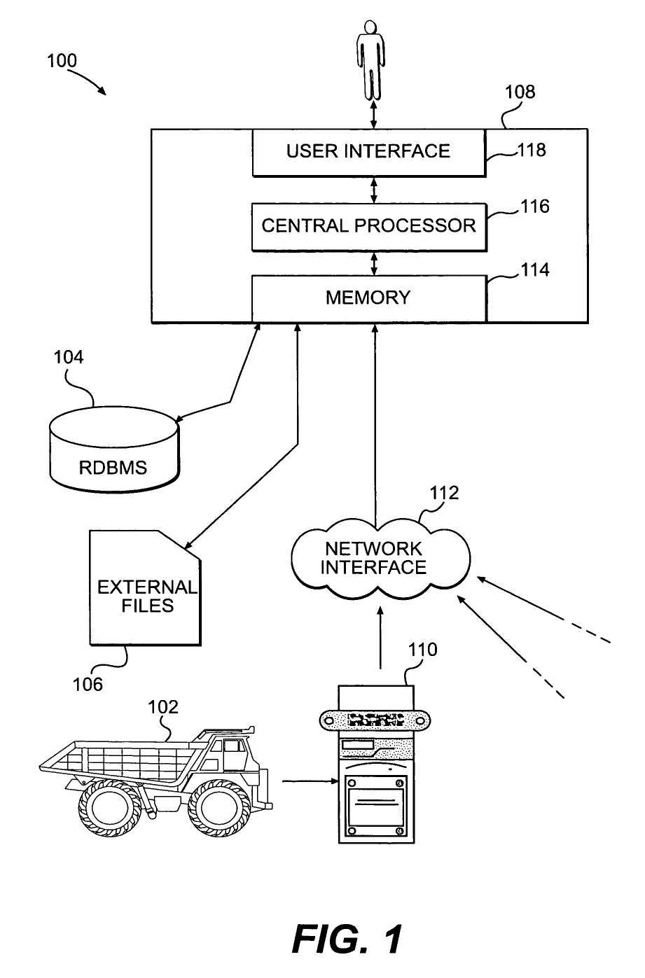

FIG. 1 provides a diagrammatic illustration of a system 100 for collecting data from work machines, such as a work machine 102, and other sources, including a relational database 104, and external files 106. The collected data may be used by a console 108 to monitor or track status of work machines geographically dispersed in a construction site, such as a mine. Work machine 102 may include one or more sensors for gathering measurements describing a state of work machine 102, an on-board processor 110 for compiling the measurements in a raw data file and for transmitting the raw data file over a network interface 112 to console 108. Other work machines (not shown) may be similarly equipped to transmit raw data files over network interface 112 to console 108.

A raw data file from work machine 102 may include measurements describing a state of work machine 102. Measurements may be taken periodically (e.g., every second) and may include thousands of measurements such as engine revolutions, various temperature readings, and suspension pressures, among others. Various data types may be defined for the different measurements. The data in a raw data file may be ordered in time (time-stamped). Therefore, any time-stamped external reference data can be compared to the raw data files, including data from a global location system such as GPS.

GPS data, for example, may be used to determine the location of a work machine when a given portion of an associated raw data file was generated.

Console 108 may include a memory 114, a central processor 116, and a user interface 118. Memory 114 in console 108 may receive and store raw data files from network interface 112. Memory 114 may receive and store external reference data including GPS data, work machine production information (describing a function of a work machine at a particular time, such as loading, dumping, traveling), and construction site data (e.g., roads information, work machine assignments, work machine delays). External files 106 may provide such reference data and may be updated by an external source.

Central processor 116 may be adapted to parse the raw data files. Central processor 116 may also parse user queries (i.e., requests for information) from user interface 118 into components, including, for example a verb component and an object component. The raw data files and queries may be parsed with an XML driven parser. The XML driven parser may also permit a user to define a raw data file format and how this format should be parsed (i.e., mapped) into a table (or tables) for processing. Based on the queries, central processor 116 may generate custom reports to be displayed by user interface 118. An XML driven table generator may be used to generate custom reports in a table view. Central processor 116 may also generate alarms in response to recognized conditions, perform Bayesian filtering to predict events, and train a neural network to identify patterns in collected data.

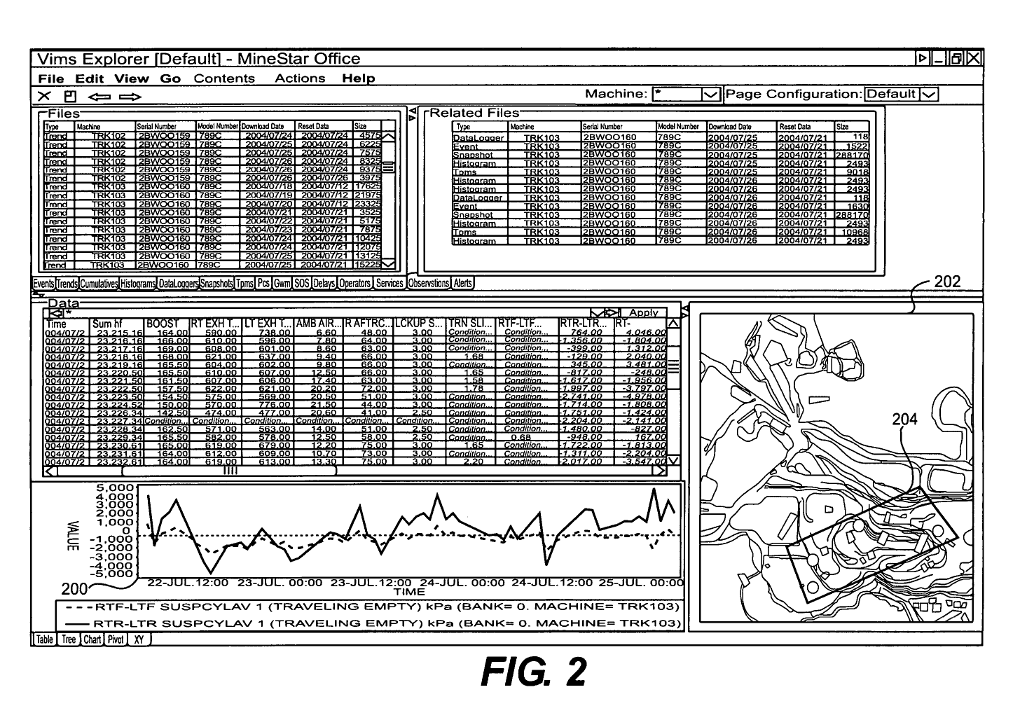

FIG. 2 provides an exemplary view of a display provided by user interface 118. User interface 118 may permit custom reports to be viewed in a standard format and, if desired, on a time chart 200 or a spatial map 202. Multiple views of the same data may be generated to provide different dissections of the data for analysis. User interface 118 may provide an interface to receive user queries (i.e., requests for information) conforming to a specified query language. User interface 118 may allow a user to construct queries having spatial and temporal relations. For example, in constructing a query, a user may define points or regions of interest on spatial map 202, as shown by polygon 204, or on time chart 200.

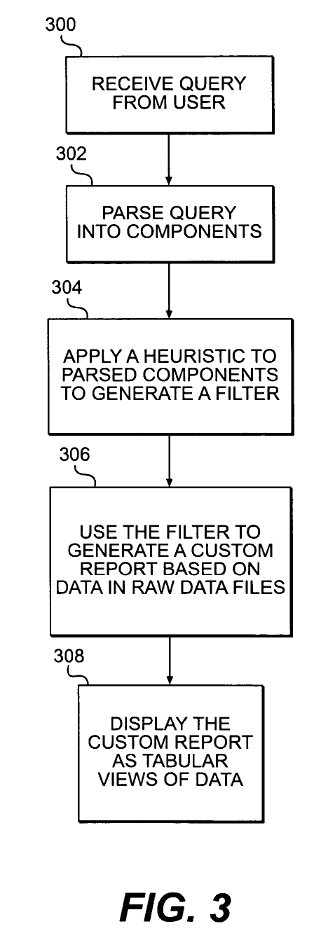

FIG. 3 provides an illustration of a method that may be carried out by console 108 to display custom reports to a user based on collected data. In step 300, user interface 118 may receive a user query. In step 302, central processor 116 may parse the query into components. In step 304, central processor 116 may apply a heuristic (i.e., a rule appropriate to a specific business domain) to the parsed components to generate a filter. In step 306, central processor 116 may use the filter to generate a custom report based on data in the raw data files and external reference data. In step 308, the custom report may be displayed as, for example, tabular views of data or chart views of data. Custom reports may be viewed, edited, printed, etc.

Steps 302 and 304 will now be explained in more detail. In step 302 a query may be parsed into components. Components may include a verb component and an object component. The verb component and object components of a query may indicate how raw data is to be filtered, e.g., which work machine(s), which measurement(s), which time frame(s) and which location(s) are of interest to the user. For example, a user may be interested in finding out what events occurred on loaded trucks leaving the North Pit during January. A query for obtaining this information may be composed as follows: “select from events where event.machine.status=‘loaded’ and event.location in ‘North Pit’ and event.timestamp>=1/1/05 and event.timestamp<=1/31/05.” In this example, “=,” “>=,” “<=,” and “in” may be verb components and “event,” “machine,” and “location” may be object components. A verb component for a location may also be “near.” In addition, as explained above, a user query may include a graphically defined region, such as polygon 204 drawn on spatial map 202 instead of identifying a region such as “North Pit.”

Queries may also be used to process raw data files in realtime as data arrives from a construction site or in batch mode as data is imported from external files 106. In this manner, similar events may be detected as they occur to trigger other operations such as activation of dataloggers or scheduling maintenance for a work machine.

In step 304, central processor 116 may apply a heuristic to the parsed components of the query to generate one or more filters to be applied to the raw data files. A heuristic may generate proximity filters, such as a proximity in space filter and/or a proximity in time filter to be applied to the raw data files. For example, a proximity in time filter may be used to compare data from work machines over a certain period of time. A proximity in space filter may be used to compare data from work machines that occupy a given region of space. For example, a heuristic may detect a parsed component such as “during 2002/2003” and interpret this as indicating a proximity in time filter. A parsed component such as “the North Pit” may indicate a proximity in space filter. A verb component, such as “is near” may indicate a broad filter, whereas “equals” may indicate a narrow filter. An object component, such as “trucks that suffered brake failure” may indicate which raw data files to join. Other types of filters may also be applied based on other arbitrary variables, and various types of filters may be combined.

In generating a filter, a heuristic may take into account knowledge of the dynamics of the motion of work machines and the layout of the construction site to intelligently associate time and location of sampled data. Such reference data may be obtained from external files 106. A heuristic may determine whether data is available to support the query. Data may be gathered at different rates or at different points in time by work machines. Therefore, a heuristic may also determine whether it is necessary to interpolate data from the raw data files before filtering to allow alignment and comparison of data on a consistent time or space axis. External reference data, such as road details, may indicate a manner of interpolation to be used. For example, if road details are absent, then “near” in a query may indicate interpolation based on a uniform distance from a point. If road details are available, then “near” may indicate a different interpolation, which takes roads into account.

In addition, console 108 may be adapted to permit users to edit or define new heuristics, as desired, to take into account new sources of data or to interpret queries differently. For example, heuristics may be interactively defined via user interface 118 to support legacy data sources as well as raw data files. Interactively defined heuristics may also be exported to be used by other systems monitoring construction sites.

### INDUSTRIAL APPLICABILITY

The disclosed system and method for analyzing raw data files may be used to analyze raw data files from any source. In one exemplary disclosed embodiment, the system and method may be used to monitor status of work machines in a construction site.

The presently disclosed system and method for analyzing raw data files has several advantages. First, the disclosed system and method do not add relational indexes and do not reformat raw data files. This is accomplished by leveraging the natural ordering of sample data in raw data files. Thus, files sizes may be reduced and more data may be stored locally instead of being archived. Local access improves speed and efficiency of analyzing the data and permits a user to make comparisons with historical data more easily to learn whether any early indications of problems were evident. Furthermore, the presently disclosed system and method do not pre-process raw data files to remove any information, thereby preserving a complete record of data for future reference.

In addition, the presently disclosed system and method permit natural queries that are easy to form ad-hoc. New procedures or heuristics for interpreting queries may be defined and ported for use on other systems.

It will be apparent to those skilled in the art that various modifications and variations can be made in the disclosed system and method for analyzing raw data files without departing from the scope of the disclosure. Additionally, other embodiments of the disclosed system will be apparent to those skilled in the art from consideration of the specification. It is intended that the specification and examples be considered as exemplary only, with a true scope of the disclosure being indicated by the following claims and their equivalents.

What is claimed is:

1. A method for generating and displaying a custom report based on raw data files, the method comprising:
receiving raw data files;
receiving a query from a user;
parsing the query into components;
applying a heuristic to the parsed components to generate a filter;
using the filter to generate the custom report based on data in the raw data files; and
displaying the custom report to the user.

2. The method of claim 1, wherein the raw data files originate from geographically dispersed sources.

3. The method of claim 1, wherein the components of the query include a verb component and an object component.

4. The method of claim 3, wherein the object component is a graphically defined polygon on a map defining a location of interest to the user.

5. The method of claim 1, wherein parsing the query into components is performed with an XML parser.

6. The method of claim 1, wherein displaying the custom report to the user includes displaying at least one of tabular views of data and chart views of data.

7. The method of claim 1, further including interpolating data in the raw data files based on external reference data, wherein the external reference data includes time-stamped data from a global location system.

8. The method of claim 1, wherein the filter includes at least one of a proximity in space filter and a proximity in time filter.

9. The method of claim 1, wherein the raw data files originate from a work machine and include measurements describing a state of the work machine.

10. A console for generating and displaying a custom report based on raw data files, the console being adapted to:
receive raw data files;
receive a query from a user;
parse the query into components;
apply a heuristic to the parsed components to generate a filter;
use the filter to generate the custom report based on data in the raw data files; and
display the custom report to the user.

11. The console of claim 10, wherein the raw data files originate from geographically dispersed sources.

12. The console of claim 10, wherein the components of the query include a verb component and an object component.

13. The console of claim 12, wherein the object component defines a location of interest to the user.

14. The console of claim 10, wherein displaying the custom report to the user includes displaying at least one of tabular views of data and chart views of data.

15. The console of claim 10, further being adapted to interpolate data in the raw data files based on time-stamped data from a global location system.

16. The console of claim 10, wherein the filter includes at least one of a proximity in space filter and a proximity in time filter.

17. The console of claim 10, wherein the raw data files originate from a work machine and include measurements describing a state of the work machine.

18. A system for generating and displaying a custom report based on raw data files, the system comprising:
at least one work machine including:
one or more sensors for gathering measurements describing a state of the at least one work machine;
a processor for compiling the measurements in a raw data file; and
a console adapted to:
receive raw data files from the at least one work machine;
receive a query from a user;
parse the query into components;
apply a heuristic to the parsed components to generate a filter;
use the filter to generate the custom report based on data in the raw data files; and
display the custom report to the user.
